(19) United States
(12) Patent Application Publication
(10) Pub. No.: US 2021/0112834 A1
(43) Pub. Date: Apr. 22, 2021

(54) EFFICIENT AND HIGH-QUALITY PREPARATION METHOD OF LYOPHILIZED VEGETABLE NOODLES

(71) Applicants: Jiangnan University, Wuxi (CN); BRILLIANCE BIO-TECH CO.,LTD., Qingdao (CN); Qingdao Zhike Inspection and Testing Limited Company, Qingdao (CN)

(72) Inventors: Min ZHANG, Wuxi (CN); Wenchao LIU, Wuxi (CN); Dongxing YU, Wuxi (CN); Wanshuai YU, Wuxi (CN); Arun S. MUJUMDAR, Wuxi (CN)

(21) Appl. No.: 16/836,334

(22) Filed: Mar. 31, 2020

(30) Foreign Application Priority Data
Oct. 22, 2019 (CN) 2019110028839

(51) Int. Cl. A23L 7/113; A21D 2/18; A21D 2/36; A21D 2/32; A21D 2/02; A21D 2/16; A21D 8/10; A21D 15/02; A21D 15/06; A21D 6/00

(52) U.S. Cl. CPC A23L 7/113; A21D 2/186; A21D 2/36; A21D 2/32; A21D 2/02; A23V 2002/00; A21D 2/16; A21D 8/10; A21D 15/02; A21D 15/06; A21D 6/008; A21D 2/183

(57) ABSTRACT

An efficient and high-quality preparation method of lyophilized vegetable noodles is disclosed, which uses high gluten wheat flour and vegetable powder as major raw materials, adds modified starch, edible salt, an emulsifier, edible colloid, a water retaining agent, edible oil, a flavoring agent, a colorant, maltodextrin and wheat gluten, and conducts rising, dough pressing, cooking, high temperature steam gelatinization, rinsing, ultrasonic treatment and infrared lyophilization to obtain convenient and instant lyophilized vegetable noodles. The lyophilized noodles processed by adopting the method have moisture content of 5%-8%, shortened drying time by more than 10 h than ordinary lyophilization, merit factor of more than 90%, easy brewing, smooth and pliable taste, strong aroma, yellowish color, long shelf life and low production power consumption. The method is an efficient preparation method of high-quality lyophilized vegetable noodles having high product yield, long shelf life, low energy consumption and applicability for industrial production.

### TECHNICAL FIELD

The present invention discloses an efficient preparation method of lyophilized vegetable noodles, and belongs to the field of food processing.

### BACKGROUND

Noodles are the traditional food in China. Various noodles on the market meet different needs of consumers. With the economic development of the society, it is a trend for people to require green consumption such as food diversification, naturalness, convenience and nutrition. The color of the noodles can be changed by adding coarse cereal powder or vegetable powder to the flour. This color is the color of the vegetables or coarse cereals, and also brings fresh fragrance and pleasant natural color. The noodles do not contain any additive, so that the appearances are more attractive to consumers and the consumers can buy the noodles with confidence. Vegetable noodles not only increase the nutrition, but also increase the appetite for food for the consumers. Moreover, the flour has nutritional defects. Thus, the texture, the processing properties and the nutritional properties of the noodles can also be improved by adding other flour. Therefore, health and nutritional noodles are the only way for the development of the noodles today.

According to the theory of phase equilibrium in thermodynamics, the temperature of the three-phase point (coexistence of three phases of steam, liquid and solid) of water is 0.0098° C. and the pressure of the three-phase point is 609.3 Pa (4.57 mmHg). Lyophilization dehydrates the materials at low temperature to achieve the purpose of drying based on the principle that ice crystals can be directly converted into gaseous water vapor when the pressure is lower than the pressure of the three-phase point. The optimum temperature for starch aging is 2-4° C., and aging does not occur above 60° C. or below −20° C. When the moisture content of food is between 30% and 60%, starch is easy to age. When the moisture content of the food is below 10% or above 60%, starch is not easy to age. The aged starch loses affinity with water, and it is not easy to interact with amylase. Thus, the starch is not easy to be digested and absorbed by the human body, which seriously affects the texture of the food, makes the noodles lose the freshness and reduces the retraction capability of noodle matrix. Large ice crystals are formed in the noodles in the process of slow freezing, which significantly increases the water leaching rate of the starch, severely damages the ultrastructure of the starch, increases pore size, reduces pore uniformity, finally significantly increases the hardness of the starch, significantly reduces elasticity, causes starch settling and generates adverse effects on the properties of the starch. In the lyophilization process, the noodles are under low temperature conditions, and are not easy to age. In addition, through the lyophilization treatment, the mucedin in the noodles has high water retention property, oil absorption and thermal stability, and the texture characteristics of the noodles such as viscoelasticity, cohesiveness, adhesiveness, chewiness and resilience are increased. Lyophilization is the most advanced technology in all current drying methods, and can maintain the original biological activity and effective ingredients of fresh food without any preservative. The noodles not only retain intact nutritional ingredients, appearance and color, but also can be stored for a long time at room temperature, and are easy to carry and transport. Forced air drying and frying greatly influence the quality of the noodles, which not only greatly changes the nutritional quality and sensory quality of the noodles, but also produces harmful ingredients. The lyophilization technology of the noodles has the potential for development and amplification. The lyophilization technology can also be applied to the fields of dehydration and drying of dumplings, meatballs and sweet dumplings. Lyophilization is used to heat and dry the materials under low temperature and vacuum conditions, which has the defects of large energy consumption and long drying time, thereby limiting the application of the lyophilization technology. The purpose of the present invention is to solve the problem of quality reduction of the noodles by lyophilization on one hand, and to reduce the energy consumption of lyophilization, shorten the production cycle of enterprise products and improve the efficiency of enterprises while ensuring the quality on the other hand.

Ye Yufen et al. (2019) disclose an edible mushroom dough sheet product which is prepared from flour, mashed mushroom, water, salt and sorbitol. The flour, the mashed mushroom, the water, the salt and the sorbitol are in the weight ratio of 1000: 20-100: 200-300: 2.0-4.0: 25-40. In addition, the present invention also provides a method for preparing the edible mushroom dough sheet product. Compared with the instant lyophilized noodle provided by the present invention, this invention mainly provides a dough sheet (including noodle, dumpling wrapper, wonton wrapper and shao-mai wrapper) primary product which is more convenient and easier to eat than the present invention. In addition, the invention uses hot air for dehydration subsequently, and the nutritional loss of the product will be greatly increased.

Zhang Hong et al. (2015) disclose a vacuum lyophilized potato noodle, a manufacturing method therefor and instant food (publication number: CN104719762A). The method comprises the following steps: step 1: manufacturing raw noodles, wherein according to mass parts, the manufactured noodles includes the following raw materials: 45-55 parts of flour, 40-50 parts of whole potato flour, 2-6 parts of wheat gluten, 1.0-2.5 parts of salt and 30-40 parts of water; step 2: cooking the raw noodles; step 3: pre-freezing: putting the cooked noodles into a mold, and freezing for 1-5 h until the cooked noodles are shaped; step 4: vacuum lyophilizing: putting the pre-frozen cooked noodles into a vacuum lyophilizing device; and drying until water activity is less than 0.6, wherein the temperature of a cold trap is −40° C. to −20° C., shelf temperature is −45° C. to −25° C., and vacuum degree is 10 Pa to 100 Pa. The invention adopts the vacuum lyophilization technology to treat the cooked noodles, so that fewer nutrients are lost and the interior of the noodles is loose and porous, which is conducive to the water absorption of the noodles and the reduction of the rehydration time of the noodles; and high-temperature frying process is not used. Compared with the present invention, this invention only uses traditional lyophilization treatment, has long production cycle and greatly increases product cost.

Song Qixiang (2009) discloses a manufacturing method for instant lyophilized noodles (publication number: CN200910191828A), which effectively solves the defects that the quality of the product is reduced and the product is deteriorated due to oxidation of oil during storage because the fried and dried noodles contain the oil, the noodles are contracted and dough structures are stiffened in hot-air drying, and the water absorption speed of the noodles is reduced in rehydration. However, this invention uses traditional lyophilization operation, has low production efficiency, needs 25 hours of drying and has high production cost.

Wang Yun (2012) discloses a noodle prepared by a solar drying technology (publication number: CN102669547A), which is prepared by the following raw materials in parts by weight: 1200-1500 of flour, 5-10 of perilla powder, 1-5 of spirulina powder, 5-10 of dietary fiber powder, 3-8 of dried asparagus powder, 3-5 of roxburgh rose lyophilized powder, 3-5 of mulberry lyophilized powder, 2-5 of ginseng extract, 5-8 of pollen pini, 1-3 of refined salt and 0.05-0.2 of edible alkali powder. In this invention, all kinds of fruit and vegetable lyophilized powder and extracts are added. The nutrition is rich while the preparation method is simple. With the addition of the spirulina powder, the noodles are elastic and god in taste. With the use of the solar drying technology, the cost is saved. However, in the noodle drying process of this invention, the quality of the noodles is obviously deteriorated, and the product quality is difficult to control.

Wang Yuchuan et al. (2003) disclose a processing method of lyophilized instant noodles and a microwave lyophilization device (publication number: CN1526305A). The method is completed through the following steps: making noodles, mixing and moulding, preparing a soup, freezing and forming, vacuum drying and packaging a finished product. The microwave lyophilization device used for vacuum drying is composed of a warehouse body, a water catcher, a guide rail, a slide rail, a crane, a supporting plate, a material tray and a microwave magnetron. Compared with the present invention, this invention is obviously non-uniform in microwave heating, resulting in the decrease of quality and the reduction of consumer acceptance.

Luo Tiezhu (2018) discloses a hericium erinaceus corn instant noodle (publication number: 108813349A). The hericium erinaceus corn instant noodle is prepared by taking corn keratin endosperm powder, corn meal endosperm powder and hericium erinaceus powder as major raw materials according to the following steps: uniformly mixing the corn keratin endosperm powder, the corn meal endosperm powder and the hericium erinaceus powder according to 1:1:0.5; adding 0.6% of mixed raw material powder of salt and 30-35% of mixed raw material powder of normal temperature drinking water; fully stirring to obtain mixed wet powder; putting the mixed wet powder into a screw extruder; extruding the mixed wet powder into cooked noodles; delivering the cooked noodles into a tempering chamber for standing and tempering; packaging the tempered noodles with food grade plastic bags, and then rapidly delivering into a freezing chamber for freezing treatment; then transferring the noodles into a freezer for storage to obtain the hericium erinaceus corn instant noodle finished product. The hericium erinaceus corn instant noodle is directly cooked for eating without immersion treatment, and has good boiling fastness, and has no turbid soup, good resilience and no fracture after long-time cooking. The noodles are smooth in the mouth and fine in taste. The frozen noodles obtained by the method increase the cost in the process of production, storage and transportation, and have poor convenience compared with the instant dry noodles of the present invention.

Lin Song et al. (2018) disclose a vegetable noodle production technology and a microwave drying device thereof (publication number: CN109751838A). The device includes a main rack. A conveyor belt and a plurality of groups of reinforcing rods are embedded in the upper end of the main rack. The plurality of groups of the reinforcing rods are located below the conveyor belt; a motor box is fixedly installed on one side of the rear surface of the main rack; a plurality of groups of drying racks are arranged in parallel on the upper surface of the conveyor belt; a drying box is fixedly installed on the upper surface of the main rack; a timing switch and a thermal circuit breaker are fixedly installed on the front surface of the drying box; the thermal circuit breaker is located on one side of the timing switch; and an exhaust component and two groups of magnetrons are fixedly installed on the upper surface of the drying box. In the vegetable noodle production technology and the microwave drying device thereof of this invention, in the process of drying vegetable noodles, the vegetable noodles can be conveniently hung and taken out; the water vapor inside the drying box can be quickly discharged in the drying process; and increase noodle cakes can also be dried, thereby increasing the functionality of the drying device. However, this invention relies on microwave heating, resulting in obvious drying non-uniformity in the production process and difficulty in controlling product quality.

Xu Yunfei (2018) discloses a noodle machine with drying function for noodle production (publication number: CN108633950A), including a movable seat. Supporting brackets are installed on both sides of the upper end of the movable seat; pressure cylinders are installed on the upper ends of the supporting brackets; pressure plates are arranged inside the left ends of the pressure cylinders; the left ends of the pressure plates are connected with pressure shafts; the left ends of the pressure shafts are hinged with pressure connecting rods; the left ends of the pressure connecting rods are hinged with first rotating wheels; the right ends of the pressure cylinders are connected with forming cylinders; forming plates are arranged inside the forming cylinders; forming shafts are connected to the middle of the upper ends of the forming plates; forming connecting rods are hinged with the upper ends of the forming shafts; second rotating wheels are hinged on the upper ends of the forming connecting rods; die heads are installed on the bottom ends of the forming cylinders; an installing seat is connected to the middle of the upper end of the movable seat; a rotary motor is installed on the upper end of the installing seat; and a drying shaft is connected to the right end of a drying connecting rod. A dried noodle product obtained by this invention is a non-instant noodle product. The convenience and the consumer favor are much lower than those of the present invention.

Xia Yuanzhen et al. (2019) disclose a processing technology for crisp instant noodles (publication number: CN109845969A). The raw materials include the following components in parts by weight: 90-110 parts of wheat flour, 30-40 parts of purified water, 4-10 parts of eggs, 1-4 parts of edible alkali, 3-8 parts of edible salt, 3-8 parts of spices, 1-4 parts of edible paprika, 1-4 parts of sauce and 1-4 parts of sesame. The processing technology for crispy instant noodles has simple, reasonable and orderly preparation steps, reasonable materials, proper material proportion, and rich nutritional components. The instant noodles are crisp and delicious, contain no any preservative and food additive, and are natural pollution-free food, thereby greatly ensuring the edibleness of the instant noodles. The ingredients can be customized for different persons according to the taste needs of the different persons, so as to adapt to convenient manufacture and production for families and food factories. The sour, sweet and salty tastes can be adjusted according to the taste needs of the different persons, so as to achieve the natural pollution-free food. The freshness and crispiness of the produced instant noodles can meet sensory needs of people. The traditional instant noodles obtained by this invention have high oil content and are inferior to the chlorophyll nutrition of the product of the present invention.

Song lixin et al. (2015) disclose a corn instant noodle (publication number: CN104824556B). The corn instant noodle is prepared by taking corn keratin endosperm powder and corn meal endosperm powder as major raw materials according to the following steps: uniformly mixing the corn keratin endosperm powder and the corn meal endosperm powder according to 1:1; adding 0.6% of mixed raw material powder of salt and 30-35% of mixed raw material powder of normal temperature drinking water; fully stirring to obtain mixed wet powder; putting the mixed wet powder into a screw extruder; extruding the mixed wet powder into cooked noodles; delivering the cooked noodles into a tempering chamber for standing and tempering; packaging the tempered noodles with food grade plastic bags, and then rapidly delivering into a freezing chamber for freezing treatment; then transferring the noodles into a freezer for storage to obtain the corn instant noodle finished product. The corn instant noodle is directly cooked for eating without immersion treatment, and has good boiling fastness, and has no turbid soup, good resilience and no fracture after long-time cooking. The noodles are smooth in the mouth and fine in taste. The frozen wet instant noodles obtained by this invention are much lower in convenience of storage and selling than the present invention.

Wang Dawei et al. (2014) disclose an additive-free five-cereal nutritional instant noodle and a production method thereof (publication number: CN104256361A). After the quality of corns and black beans are optimized, the corns, the black beans, wheat, polished round-grained rice and yellow millet are milled, blended, cured and shaped to produce the five-cereal nutritional instant noodle. The five-cereal nutritional noodle obtained by this invention give full play to the complementary advantages of rice, flour and beans, and obtains higher nutritional value. The product has good resilience, tenacity and reconstitution property, does not require dipping cook, can be eaten after immersed in boiling water, and is convenient and rapid. In the production process of the product, the conditions are mild; any chemical and biosynthesis technology is not used; pollution, waste residues, waste steam, waste water and hazardous substances are not produced, thereby realizing green production; any gluten fortifier, thickening colloid, enzyme preparation and preservative are not added; any chemical reagent is not used; and the product is safe to eat. Compared with the present invention, the product is dehydrated in a tunnel type circulating drying furnace with humidity control and temperature control, and is lower in product quality and consumer acceptance.

### SUMMARY

The present invention aims to provide a method for improving the quality of lyophilized noodles by ultrasonic treatment and infrared drying: using high gluten wheat flour and vegetable powder as major raw materials, adding modified starch, edible salt, an emulsifier, edible colloid, a water retaining agent, edible oil, a flavoring agent, a colorant, maltodextrin and wheat gluten, and conducting cooking, high temperature steam gelatinization, ultrasonic treatment and infrared lyophilization to obtain convenient and instant lyophilized noodle products.

The technical solution of the present invention is:

An efficient and high-quality preparation method of lyophilized vegetable noodles comprises: using high gluten wheat flour and vegetable powder as major raw materials, adding modified starch, edible salt, an emulsifier, edible colloid, a water retaining agent, edible oil, a flavoring agent, a colorant, maltodextrin and wheat gluten, and conducting cooking, high temperature steam gelatinization, ultrasonic treatment and infrared lyophilization to obtain convenient and instant lyophilized noodle products. Specific steps are as follows:

(1) Raw material pretreatment: mixing high gluten wheat flour, water, oil, vegetable powder and phospholipid in proportion, and homogenizing with a homogenizer for 3-10 min to fully mix the above materials; uniformly mixing modified starch, edible salt, an emulsifier, edible colloid, a water retaining agent, edible oil, a flavoring agent, a colorant, maltodextrin and wheat gluten in proportion for later use;

Further, according to mass parts, the addition amounts of various raw materials are respectively: 200-230 parts of high gluten wheat flour, 70-85 parts of water, 4-6 parts of oil, 10-20 parts of vegetable powder, 0.16-0.19 part of phospholipid, 6-8 parts of modified starch, 4-6 parts of edible salt, 0.02-0.05 part of emulsifier, 0.4-0.8 part of edible colloid, 1-1.5 parts of water retaining agent, 4-6 parts of edible oil, 0.08-0.10 part of flavoring agent, 0.018-0.020 part of colorant, 0.02-0.06 part of maltodextrin and 16-24 parts of wheat gluten.

Further, the modified starch is hydroxypropyl phosphate distarch, and has the characteristics that swelling power and transparency are still significantly higher than those of native starch, and paste has high stability for temperature, acidity and shear force; the preparation process is as follows: according to the mass parts, adding 180-190 parts of purified water to 100-150 parts of corn starch, and then adding 16-20 parts of propylene oxide for etherifying at 50-55° C. for 3.5-4.0 h; adding 1.5-1.8 parts of sodium hexametaphosphate to the etherification product to conduct a crosslinking reaction for 4.0-4.5 h; washing the above crosslinking reaction product with the purified water to remove impurities through four-stage cyclone washing; and drying the washed product at 105-110° C. for 5-5.5 h to obtain the modified starch which is the hydroxypropyl phosphate distarch.

Further, the emulsifier is fatty acid monoglyceride, soybean phospholipid, sucrose ester or sorbitol ester.

Further, the edible colloid is one or a mixture of more than one of guar gum, xanthan gum and locust bean gum.

Further, the water retaining agent is one or a mixture of more than one of sodium hexametaphosphate, sodium dihydrogen phosphate and sodium tripolyphosphate.

Further, the flavoring agent is one or a mixture of more than one of disodium 5′-ribonucleotide and sodium L-glutamate.

Further, the colorant is one or a mixture of more than one of gardenia yellow, riboflavin and curcumin.

Further, the vegetable powder is one or a mixture of more than one of spinach powder, tomato powder, yam powder, kale powder, potato powder, buckwheat powder, okra powder, wolfberry powder, agaricus bisporus powder and maca powder.

(2) Dough preparation: mixing the raw materials obtained in the step (1) into a dough batch, and beating the dough for 20-30 min to obtain standby dough.

(3) Dough rising: covering the dough obtained in the step (2) with a plastic wrap to prevent water from evaporating, and making the dough rise at 20-30° C. for 30-40 min.

(4) Dough pressing: firstly cutting the dough after rising into thick sheets to facilitate subsequent pressing; then, repeatedly rolling the thick sheets to thin sheets; repeatedly rolling from the thick sheets to the thin sheets for 2-3 cycles, i.e., pressing into a dough sheet with a thickness of 1 mm; sprinkling with flour; finally, pressing the dough sheet into noodles by using the dough cutting function of a noodle press, and sprinkling with the flour to prevent the noodles from sticking.

(5) Cooking and rinsing: putting the noodles obtained in the step (4) into a pot when water temperature reaches 50-60° C.; cooking for 6-8 min after the water is boiled; taking out the noodles and putting into cold water at 0° C.; standing for 3-7 min, and then taking out the noodles for later use.

(6) High temperature steam gelatinization and rinsing: putting the half-cooked noodles obtained in the step (5) into high temperature steam at 200-300° C. and 3-3.5 MPa for continuous treatment for 10-15 min; then putting the noodles into cold water at 0° C.; standing for 3-7 min, and then taking out the noodles for later use.

(7) Ultrasonic treatment: loading ultrasound to the noodles obtained in the step (6) for treatment, wherein the ultrasonic power is 40 KHz, the treatment time is 6-7 min, the power is 600 W/kg and treatment temperature is 20° C.

(8) Infrared lyophilization: quickly freezing the noodles obtained in the step (7) in a refrigerator at −50° C. for 7-8 h, and after taking out, putting the noodles into a lyophilization warehouse for infrared lyophilization and dehydration,wherein an infrared lyophilization and dehydration technology is as follows: temperature of a cold trap is −40° C.; system pressure intensity is 80 Pa; infrared light source wavelength is 2.4-3 μm; irradiation power is 0.7-0.9 W/cm²; irradiation distance is 80 mm; and drying time under system pressure is 10-15 h, until the moisture content of the noodles is 5-8%.

The present invention has the beneficial effects: the lyophilized noodles processed by adopting the method of the present invention have moisture content of 5%-8%, easy brewing, smooth and pliable taste, strong aroma, yellowish color, long shelf life, shortened drying time by 10 h than ordinary lyophilization and merit factor of more than 90%. The present invention is an efficient and high-quality preparation method of lyophilized vegetable noodles having high product yield, long shelf life, simple process flow, low energy consumption and applicability for industrial production.

### DETAILED DESCRIPTION

The technical solution of the present invention is further described below in combination with specific embodiments.

Embodiment 1: a method for improving quality of spinach lyophilized noodles

Weighing 200 g of high gluten wheat flour, 80 g of water, 5 g of soybean oil, 15 g of spinach powder, 0.16 g of phospholipid, 7 g of hydroxypropyl phosphate distarch, 6 g of edible salt, 0.04 g of fatty acid monoglyceride, 0.4 g of guar gum, 0.75 g of sodium hexametaphosphate, 0.35 g of sodium dihydrogen phosphate, 5 g of olive oil, 0.04 g of disodium 5′-ribonucleotide, 0.05 g of sodium L-glutamate, 0.012 g of gardenia yellow, 0.006 g of riboflavin, 0.06 g of maltodextrin and 18 g of wheat gluten; mixing the high gluten wheat flour, the water, the oil, the vegetable powder and the phospholipid in proportion, and homogenizing with a homogenizer for 7 min to fully mix the above materials; uniformly mixing the hydroxypropyl phosphate distarch, the edible salt, the fatty acid monoglyceride, the guar gum, the sodium hexametaphosphate, the sodium dihydrogen phosphate, the olive oil, the disodium 5′-ribonucleotide, the sodium L-glutamate, the gardenia yellow, the riboflavin, the maltodextrin and the wheat gluten; putting the mixture into a dough batch; beating the dough for 20 min to obtain a standby dough; covering the dough with a plastic wrap to prevent water from evaporating, and making the dough rise at 25° C. for 30 min; firstly cutting the dough after rising into thick sheets with thickness of about 1 cm by using a knife to facilitate subsequent pressing; then, repeatedly rolling the dough blocks to thin sheets; repeatedly rolling from the thick sheets to the thin sheets for 3 cycles, i.e., pressing into a dough sheet with a thickness of about 1 mm; sprinkling with a little flour; finally, pressing the dough sheet into noodles with a width of about 3 mm by using the dough cutting function of a noodle press, putting the noodles into a basin and sprinkling with a little flour to prevent the noodles from sticking; putting the noodles into a pot when water temperature reaches 50° C.; cooking for 6 min after the water is boiled; taking out the noodles and putting into cold water at 0° C.; standing for 5 min, and then taking out the noodles for later use; rinsing the cooked noodles with cold water, and putting into high temperature steam at 200° C. and 3 MPa for continuous treatment for 10 min; then putting the noodles into cold water (0° C.); after 3 min, taking out the noodles for later use; loading ultrasound to the noodles obtained in the previous step for treatment, wherein the ultrasonic power is 40 KHz, the treatment time is 7 min, the power is 600 W/kg and treatment temperature is 20° C.; quickly freezing the noodles after ultrasonic treatment in a refrigerator at −50° C. for 7 h, and after taking out, putting the noodles into a lyophilization warehouse for infrared lyophilization and dehydration; a drying technology is as follows: temperature of a cold trap is −40° C.; system pressure intensity is 80 Pa; infrared light source wavelength is 2.4 μm; irradiation power is 0.9 W/cm²; irradiation distance is 80 mm; and drying time under system pressure is 10.5 h, until the moisture content of the noodles is 5% to obtain the convenient lyophilized spinach noodles. The drying time is shortened by 13 h than ordinary lyophilization, and the merit factor is 92%.

Embodiment 2: a method for improving quality of tomato lyophilized noodles

Weighing 220 g of high gluten wheat flour, 85 g of water, 6 g of soybean oil, 18 g of tomato powder, 0.18 g of phospholipid, 8 g of hydroxypropyl phosphate distarch, 5 g of edible salt, 0.03 g of sucrose ester, 0.3 g of guar gum, 0.3 g of xanthan gum, 0.55 g of sodium hexametaphosphate, 0.85 g of sodium tripolyphosphate, 4 g of olive oil, 0.04 g of disodium 5′-ribonucleotide, 0.05 g of sodium L-glutamate, 0.011 g of gardenia yellow, 0.008 g of curcumin, 0.05 g of maltodextrin and 20 g of wheat gluten; mixing the high gluten wheat flour, the water, the oil, the vegetable powder and the phospholipid in proportion, and homogenizing with a homogenizer for 7 min to fully mix the above materials; uniformly mixing the hydroxypropyl phosphate distarch, the edible salt, the sucrose ester, the guar gum, the xanthan gum, the sodium hexametaphosphate, the sodium tripolyphosphate, the olive oil, the disodium 5′-ribonucleotide, the sodium L-glutamate, the gardenia yellow, the curcumin, the maltodextrin and the wheat gluten; putting the mixture into a dough batch; beating the dough for 20 min to obtain a standby dough; covering the dough with a plastic wrap to prevent water from evaporating, and making the dough rise at 25° C. for 30 min; firstly cutting the dough after rising into thick sheets with thickness of about 1 cm by using a knife to facilitate subsequent pressing; then, repeatedly rolling the dough blocks to thin sheets; repeatedly rolling from the thick sheets to the thin sheets for 2 cycles, i.e., pressing into a dough sheet with a thickness of about 1 mm; sprinkling with a little flour; finally, pressing the dough sheet into noodles with a width of about 3 mm by using the dough cutting function of a noodle press, putting the noodles into a basin and sprinkling with a little flour to prevent the noodles from sticking; putting the noodles into a pot when water temperature reaches 60° C.; cooking for 8 min after the water is boiled; taking out the noodles and putting into cold water at 0° C.; standing for 7 min, and then taking out the noodles for later use; rinsing the cooked noodles with cold water, and putting into high temperature steam at 220° C. and 5 MPa for continuous treatment for 12 min; then putting the noodles into cold water (0° C.); after 5 min, taking out the noodles for later use; loading ultrasound to the noodles obtained in the previous step for treatment, wherein the ultrasonic power is 40 KHz, the treatment time is 7 min, the power is 600 W/kg and treatment temperature is 20° C.; quickly freezing the noodles after ultrasonic treatment in a refrigerator at −50° C. for 7 h, and after taking out, putting the noodles into a lyophilization warehouse for infrared lyophilization and dehydration; a drying technology is as follows: temperature of a cold trap is −40° C.; system pressure intensity is 80 Pa; infrared light source wavelength is 3 μm; irradiation power is 0.75 W/cm²; irradiation distance is 80 mm; and drying time under system pressure is 15 h, until the moisture content of the noodles is 5% to obtain the convenient lyophilized tomato noodles. The drying time is shortened by 11 h than ordinary lyophilization, and the merit factor is 95%.

1. An efficient and high-quality preparation method of lyophilized vegetable noodles, comprising:
(1) raw material pretreatment: mixing high gluten wheat flour, water, oil, vegetable powder and phospholipid in proportion, and homogenizing with a homogenizer for 3-10 min to fully mix the above materials; uniformly mixing modified starch, edible salt, an emulsifier, edible colloid, a water retaining agent, edible oil, a flavoring agent, a colorant, maltodextrin and wheat gluten in proportion for later use; the modified starch is hydroxypropyl phosphate distarch;
(2) dough preparation: mixing all the components listed in step (1), which are the raw materials obtained in the step (1), into a dough batch, and beating the dough for 20-30 min to obtain standby dough;
(3) dough rising: covering the dough obtained in the step (2) with a plastic wrap to prevent water from evaporating, and making the dough rise at 20-30° C. for 30-40 min;
(4) dough pressing: firstly cutting the dough after rising into thick sheets to facilitate subsequent pressing; then, repeatedly rolling from the thick sheets to thin sheets for 2-3 cycles, i.e., pressing into a dough sheet with a thickness of 1mm; sprinkling with flour; finally, pressing the dough sheet into noodles by using a dough cutting function of a noodle press, and sprinkling with the flour to prevent the noodles from sticking;
(5) cooking and rinsing: putting the noodles obtained in the step (4) into a pot when water temperature reaches 50-60° C.; cooking for 6-8 min after the water is boiled; taking out the noodles and putting into cold water at 0° C.; standing for 3-7 min, and then taking out the noodles for later use;
(6) high temperature steam gelatinization and rinsing: putting the half-cooked noodles obtained in the step (5) into high temperature steam at 200-300° C. and 3-3.5 MPa for continuous treatment for 10-15 min; then putting the noodles into cold water at 0° C.; standing for 3-7 min, and then taking out the noodles for later use;
(7) ultrasonic treatment: loading ultrasound to the noodles obtained in the step (6) for treatment, wherein the ultrasonic power is 40 KHz, the treatment time is 6-7 min, the power is 600 W/kg and treatment temperature is 20° C.;
(8) infrared lyophilization: quickly freezing the noodles obtained in the step (7) in a refrigerator at −50° C. for 7-8 h, and after taking out, putting the noodles into a lyophilization warehouse for infrared lyophilization and dehydration, wherein an infrared lyophilization and dehydration technology is as follows: temperature of a cold trap is −40° C.; system pressure intensity is 80 Pa; infrared light source wavelength is 2.4-3 μm; irradiation power is 0.7-0.9 W/cm²; irradiation distance is 80 mm; and drying time under system pressure is 10-15 h, until a moisture content of the noodles is 5-8%.

2. The efficient and high-quality preparation method of lyophilized vegetable noodles according to claim 1, wherein in the step (1), according to mass parts, the addition amounts of various raw materials are respectively: 200-230 parts of high gluten wheat flour, 70-85 parts of water, 4-6 parts of oil, 10-20 parts of vegetable powder, 0.16-0.19 part of phospholipid, 6-8 parts of modified starch, 4-6 parts of edible salt, 0.02-0.05 part of emulsifier, 0.4-0.8 part of edible colloid, 1-1.5 parts of water retaining agent, 4-6 parts of edible oil, 0.08-0.10 part of flavoring agent, 0.018-0.020 part of colorant, 0.02-0.06 part of maltodextrin and 16-24 parts of wheat gluten.

3. The efficient and high-quality preparation method of lyophilized vegetable noodles according to claim 1, wherein in the step (1), the preparation process of the hydroxypropyl phosphate distarch is as follows: adding 180-190 parts of purified water to 100-150 parts of corn starch, and then adding 16-20 parts of propylene oxide for etherifying at 50-55° C. for 3.5-4.0 h; adding 1.5-1.8 parts of sodium hexametaphosphate to the etherification product to conduct a crosslinking reaction for 4.0-4.5 h; washing the above crosslinking reaction product with the purified water to remove impurities through four-stage cyclone washing; and drying the washed product at 105-110° C. for 5-5.5 h to obtain the modified starch which is the hydroxypropyl phosphate distarch.

4. The efficient and high-quality preparation method of lyophilized vegetable noodles according to claim 1, wherein in the step (1), the emulsifier is fatty acid monoglyceride, soybean phospholipid, sucrose ester or sorbitol ester.

5. The efficient and high-quality preparation method of lyophilized vegetable noodles according to claim 3, wherein in the step (1), the emulsifier is fatty acid monoglyceride, soybean phospholipid, sucrose ester or sorbitol ester.

6. The efficient and high-quality preparation method of lyophilized vegetable noodles according to claim 1, wherein in the step (1), the water retaining agent is one or a mixture of more than one of sodium hexametaphosphate, sodium dihydrogen phosphate and sodium tripolyphosphate.

7. The efficient and high-quality preparation method of lyophilized vegetable noodles according to claim 3, wherein in the step (1), the water retaining agent is one or a mixture of more than one of sodium hexametaphosphate, sodium dihydrogen phosphate and sodium tripolyphosphate.

8. The efficient and high-quality preparation method of lyophilized vegetable noodles according to claim 4, wherein in the step (1), the water retaining agent is one or a mixture of more than one of sodium hexametaphosphate, sodium dihydrogen phosphate and sodium tripolyphosphate.

9. The efficient and high-quality preparation method of lyophilized vegetable noodles according to claim 1, wherein the edible colloid is one or a mixture of more than one of guar gum, xanthan gum and locust bean gum; the flavoring agent is one or a mixture of more than one of disodium 5′-ribonucleotide and sodium L-glutamate; the colorant is one or a mixture of more than one of gardenia yellow, riboflavin and curcumin; and the vegetable powder is one or a mixture of more than one of spinach powder, tomato powder, kale powder, yam powder, potato powder, buckwheat powder, okra powder, wolfberry powder, agaricus bisporus powder and maca powder.

10. The efficient preparation method of lyophilized vegetable noodles according to claim 6, wherein the edible colloid is one or a mixture of more than one of guar gum, xanthan gum and locust bean gum; the flavoring agent is one or a mixture of more than one of disodium 5′-ribonucleotide and sodium L-glutamate; the colorant is one or a mixture of more than one of gardenia yellow, riboflavin and curcumin; and the vegetable powder is one or a mixture of more than one of spinach powder, tomato powder, kale powder, yam powder, potato powder, buckwheat powder, okra powder, wolfberry powder, agaricus bisporus powder and maca powder.
